(19) United States
(12) Patent Application Publication
(10) Pub. No.: US 2026/0244934 A1
(43) Pub. Date: Aug. 20, 2026

(54) Method And Apparatus For Transforming Artificial Intelligence Model Between Framework And Intermediate Representation

(71) Applicant: NOTA, INC., Daejeon (KR)

(72) Inventors: Huiseong GIM, Daejeon (KR); Donggeun KIM, Daejeon (KR); Shinkook CHOI, Daejeon (KR)

(73) Assignee: NOTA, INC., Daejeon (KR)

(21) Appl. No.: 19/349,051

(22) Filed: Oct. 3, 2025

(30) Foreign Application Priority Data
Feb. 20, 2025 (KR) 10-2025-0022595
Jul. 25, 2025 (KR) 10-2025-0101731

(51) Int. Cl. G06N 3/0895; G06N 3/045

(52) U.S. Cl. CPC G06N 3/0895; G06N 3/045

(57) ABSTRACT

In one embodiment, a method for transforming an artificial model between a framework and an intermediate representation, performed by a computing device, is disclosed. The method may comprise: receiving target model operator information regarding target model operators executable in a target framework; determining a target module corresponding to each of the target model operators from the target model operator information, based on an execution-based analysis method using execution of a test artificial intelligence model, or an embedding-based analysis method using embedding transformation between a model operator and an atomic operator independent of a framework; and generating a target mapping table for the target framework by mapping each of the target model operators and the determined target module, and wherein the target module, as the intermediate representation of the target model operator, is composed of a combination of one or more nodes corresponding to the atomic operator.

### CROSS-REFERENCE TO RELATED APPLICATIONS

This application claims priority to and the benefit of Korean Patent Application No. 10-2025-0101731 filed in the Korean Intellectual Property Office on Jul. 25, 2025, Korean Patent Application No. 10-2025-0022595 filed in the Korean Intellectual Property Office on Feb. 20, 2025, the entire contents of which are incorporated herein by reference.

### TECHNICAL FIELD

This disclosure relates to artificial intelligence technology, and more particularly, to method and apparatus for transforming artificial intelligence model between framework and intermediate representation.

### BACKGROUND ART

With the recent rapid advancement of artificial intelligence technology, various types of artificial intelligence models have been developed. Such artificial intelligence models are generally developed and implemented based on a specific framework such as TensorFlow, PyTorch, or ONNX, and each framework has its own unique model configuration method, operation processing method, and data representation method. A framework may be optimized for a specific execution environment, such as specific hardware (for example, CPU, GPU, NPU, FPGA, edge device, etc.), a specific compiler, or a specific service environment (for example, web server, mobile application, cloud, etc.).

Meanwhile, in order for an artificial intelligence model to be optimized for various execution environments, there may be cases where it needs to be converted from the framework-specific representation into a more general intermediate representation (IR). The intermediate representation is not dependent on a framework, and allows hardware or a compiler to interpret and process the structure and operations of the model in a standardized form.

Korean Patent Publication No. 10-2024-0097680, published on Jun. 27, 2024, can be considered prior art.

### SUMMARY OF THE INVENTION

The present disclosure has been contrived in response to the above-described background art, and has been made in an effort to provide a method and an apparatus for transforming artificial intelligence model between framework and intermediate representation.

Technical objects of the present disclosure are not restricted to the technical object mentioned as above. Other unmentioned technical objects will be apparently appreciated by those skilled in the art by referencing the following description.

According to one aspect of the present disclosure for achieving the above-described object, a method for transforming an artificial model between a framework and an intermediate representation, performed by a computing device, is disclosed. The method may comprise: receiving target model operator information regarding target model operators executable in a target framework; determining a target module corresponding to each of the target model operators from the target model operator information, based on an execution-based analysis method using execution of a test artificial intelligence model, or an embedding-based analysis method using embedding transformation between a model operator and an atomic operator independent of a framework; and generating a target mapping table for the target framework by mapping each of the target model operators and the determined target module, and wherein the target module, as the intermediate representation of the target model operator, is composed of a combination of one or more nodes corresponding to the atomic operator.

In one embodiment, when the target framework is a first framework, the target module may be determined based on a first execution-based analysis method of tracing atomic operators called during execution of the test artificial intelligence model, and when the target framework is a second framework, the target module may be determined based on a second execution-based analysis method of comparing execution results of the test artificial intelligence model or based on the embedding-based analysis method.

In one embodiment, the first framework may correspond to a framework supporting a function of converting model operators included in the test artificial intelligence model into an intermediate representation structure expressed in units of atomic operators, and the second framework may correspond to a framework not supporting a function of converting model operators included in the test artificial intelligence model into an intermediate representation structure expressed in units of atomic operators.

In one embodiment, the target framework may be the second framework, the determining the target module is performed after generating a first mapping table for the first framework.

In one embodiment, when the target framework is the second framework, the target module may be determined based on: generating a candidate mapping table corresponding to the target framework based on the second execution-based analysis method or the embedding-based analysis method, the candidate mapping table corresponding to a table in which one or more candidate modules are mapped to one target model operator; and determining the target module corresponding to each of the target model operators by comparing execution results of each of the target model operators and execution results of each of the one or more candidate modules mapped in the candidate mapping table, and the generating the candidate mapping table may be performed using a plurality of first modules predetermined for the first framework.

In one embodiment, when the target framework is the first framework, the determining the target module may comprise: generating a first test artificial intelligence model including the target model operators; converting the target model operators included in the first test artificial intelligence model into a first intermediate representation structure expressed in units of atomic operators by executing the first test artificial intelligence model; identifying, based on the target model operator information, a combination of atomic operators corresponding to each of the target model operators and an execution order thereof in the first intermediate representation structure; and determining the target module corresponding to each of the target model operators based on the identified combination of atomic operators and the execution order.

In one embodiment, when the target framework is the second framework, the determining the target module may comprise: generating a second test artificial intelligence model including the target model operators; and determining the target module corresponding to each of the target model operators included in the second test artificial intelligence model, based on execution results of first input data for the second test artificial intelligence model and execution results of the first input data for a plurality of pre-stored candidate modules, and the plurality of pre-stored candidate modules may correspond to a plurality of first modules predetermined for the first framework.

In one embodiment, the second test artificial intelligence model may consist of a single first target model operator, and the determining the target module based on execution results of the first input data for the second test artificial intelligence model and execution results of the first input data for the plurality of pre-stored candidate modules may comprise: generating an error between execution results of the first input data for the first target model operator and execution results of the first input data for the plurality of pre-stored candidate modules; identifying one or more candidate modules among the plurality of pre-stored candidate modules in which the error is less than or equal to a threshold error; and determining the target module corresponding to the first target model operator among the identified one or more candidate modules, by comparing execution results of second input data for the first target model operator and execution results of the second input data for the identified one or more candidate modules.

In one embodiment, the determining the target module based on execution results of the first input data for the second test artificial intelligence model and execution results of the first input data for the plurality of pre-stored candidate modules may comprise: generating an error between execution results of the first input data for the second test artificial intelligence model and execution results of the first input data for candidate module combinations composed of the plurality of pre-stored candidate modules; identifying one or more candidate module combinations in which the error is less than or equal to a threshold error among the candidate module combinations; and determining the target module corresponding to each of the target model operators included in the second test artificial intelligence model within the identified one or more candidate module combinations, by comparing execution results of third input data for each of the target model operators and execution results of the third input data for each of the candidate modules included in the identified one or more candidate module combinations.

In one embodiment, the second test artificial intelligence model may include a second target model operator and a third target model operator, the third target model operator receiving an output value of the second target model operator, and the determining the target module based on execution results of the first input data for the second test artificial intelligence model and execution results of the first input data for the plurality of pre-stored candidate modules may comprise: generating a first error between a first intermediate execution result of the second target model operator for the first input data and execution results of the first input data for the plurality of pre-stored candidate modules; identifying one or more first candidate modules among the plurality of pre-stored candidate modules in which the first error is less than or equal to a threshold error; generating a second error between a second intermediate execution result output by the third target model operator using the first intermediate execution result as input and execution results output by the plurality of pre-stored candidate modules using the first intermediate execution result as input; identifying one or more second candidate modules among the plurality of pre-stored candidate modules in which the second error is less than or equal to the threshold error; and determining the target module corresponding to each of the second target model operator and the third target model operator, based on the identified one or more first candidate modules and the identified one or more second candidate modules.

In one embodiment, the determining the target module may comprise: generating a target model operator embedding vector corresponding to each of the target model operators based on the target model operator information; generating an atomic operator embedding vector corresponding to each of atomic operators based on information regarding the atomic operators; and determining the target module corresponding to each of the target model operators based on a vector similarity between the target model operator embedding vector and the atomic operator embedding vector.

In one embodiment, the target model operator embedding vector may be generated by performing a filtering process of deleting tokens corresponding to predefined stopwords or selecting tokens corresponding to predefined keywords for a plurality of target model operator tokens obtained by tokenizing the target model operator information corresponding to each of the target model operators, and the atomic operator embedding vector may be generated by performing a filtering process of deleting tokens corresponding to the predefined stopwords or selecting tokens corresponding to the predefined keywords for a plurality of atomic operator tokens obtained by tokenizing the information regarding the atomic operators.

In one embodiment, the determining the target module based on the vector similarity may comprise: determining one or more candidate atomic operators corresponding to one or more atomic operator embedding vectors in which the vector similarity with the target model operator embedding vector corresponding to a fourth target model operator is greater than or equal to a threshold vector similarity; identifying one or more candidate modules including the one or more candidate atomic operators among a plurality of pre-stored candidate modules; and determining the target module corresponding to the fourth target model operator among the identified one or more candidate modules by comparing execution results of fourth input data for the fourth target model operator and execution results of the fourth input data for the identified one or more candidate modules, and the plurality of pre-stored candidate modules may correspond to a plurality of first modules predetermined for the first framework.

In one embodiment, the target model operator information may include identification information, description information, input/output information, and implementation code of each of the target model operators, the description information may be information in which a description of each of the target model operators is written in natural language text, and the input/output information may include data type, shape, and order information of input values and output values of each of the target model operators.

In one embodiment, the receiving the target model operator information may comprise receiving the target model operator information by version of the target framework, the target mapping table may include the version-based target mapping table for the target framework, and the method may further comprise: generating modification information including a modification between the target model operator information on a first version of the target framework and the target model operator information on a second version of the target framework; determining a modified module corresponding to a modified model operator, in which the target model operator information has been modified, among the target model operators, from the modification information based on the execution-based analysis method or the embedding-based analysis method; and generating the target mapping table of the second version by mapping the modified model operator and the determined modified module.

In one embodiment, the target mapping table may include version information of the framework, identification information of the target model operator, input/output information of the target model operator, identification information of one or more nodes included in the target module mapped to the target model operator, input/output information of the one or more nodes, and an execution order of each node.

In one embodiment, the intermediate representation may have a hierarchical structure including nodes independent of the framework and modules dependent on the framework, and one or more nodes may constitute a single module within the hierarchical structure.

In one embodiment, the method may further comprise: determining a target model operator corresponding to each of atomic operators based on a mapping relation between each of the target model operators and the determined target module; and generating a target reverse mapping table by mapping each of the atomic operators and the determined target model operator.

According to one aspect of the present disclosure, a non-transitory computer-readable medium storing a computer program is disclosed. When executed by a computing device, the computer program may allow the computing device to perform operations for transforming an artificial model between a framework and an intermediate representation, the operations comprising: receiving target model operator information regarding target model operators executable in a target framework; determining a target module corresponding to each of the target model operators from the target model operator information, based on an execution-based analysis method using execution of a test artificial intelligence model, or an embedding-based analysis method using embedding transformation between a model operator and an atomic operator independent of a framework; and generating a target mapping table for the target framework by mapping each of the target model operators and the determined target module, and wherein the target module, as the intermediate representation of the target model operator, is composed of a combination of one or more nodes corresponding to the atomic operator.

According to one aspect of the present disclosure, a computing device for transforming an artificial model between a framework and an intermediate representation is disclosed. The computer device may comprise a processor including at least one core, wherein the processor is configured to: receive target model operator information regarding target model operators executable in a target framework; determine a target module corresponding to each of the target model operators from the target model operator information, based on an execution-based analysis method using execution of a test artificial intelligence model, or an embedding-based analysis method using embedding transformation between a model operator and an atomic operator independent of a framework; and generate a target mapping table for the target framework by mapping each of the target model operators and the determined target module, wherein the target module, as the intermediate representation of the target model operator, is composed of a combination of one or more nodes corresponding to the atomic operator.

According to some embodiments of the present disclosure, it is possible to provide a method and an apparatus for transforming an artificial model between a framework and an intermediate representation. For example, through the present disclosure, by generating a mapping table between operators of various frameworks and an intermediate representation, a technical effect can be achieved in that conversion between different frameworks can be easily implemented.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following embodiments, for purposes of explanation, numerous specific detailed matters are presented to provide a comprehensive understanding of one or more aspects. However, it will be apparent that the aspect(s) can be executed without the specific detailed matters. In other examples, known structures and apparatuses are illustrated in a block diagram form in order to facilitate description of one or more aspects.

FIG. 1 is a block diagram of a computing device for a method and an apparatus for transforming an artificial model between a framework and an intermediate representation according to one embodiment of the present disclosure.

FIG. 2 is a schematic diagram illustrating a network function according to one embodiment of the present disclosure.

FIG. 3 is a flowchart illustrating a method for transforming an artificial model between a framework and an intermediate representation by a computing device according to one embodiment of the present disclosure.

FIG. 4 is an exemplary diagram illustrating a mapping table generating system implemented by a computing device according to an embodiment of the present disclosure.

FIG. 5 is an exemplary diagram illustrating a process of generating a mapping table according to an embodiment of the present disclosure.

FIG. 6 is an exemplary diagram illustrating a process of converting a model operator into a module of an intermediate representation structure according to an embodiment of the present disclosure.

FIG. 7 is a flowchart illustrating a method for converting a model operator of a first framework into an intermediate representation using an execution-based analysis method, performed by a computing device according to an embodiment of the present disclosure.

FIG. 8 is a flowchart illustrating a method for converting a model operator of a second framework into an intermediate representation using an execution-based analysis method, performed by a computing device according to an embodiment of the present disclosure.

FIG. 9 is a flowchart illustrating a method for converting a model operator into an intermediate representation using an embedding-based analysis method, performed by a computing device according to an embodiment of the present disclosure.

FIG. 10 is a simple and normal schematic diagram of an exemplary computing environment in which the exemplary embodiments of the present disclosure may be implemented.

### DETAILED DESCRIPTION

Various exemplary embodiments will now be described with reference to drawings. In this specification, various descriptions are presented to provide appreciation of the present disclosure. However, it will be apparent that these embodiments may be implemented without the specific descriptions set forth herein.

“Component”, “module”, and “system” which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, an application executed on a computing device, as well as the computing device itself, may constitute components. One or more components may reside within the processor and/or a thread of execution.

The component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “or” and “and/or” used in this specification designates and includes all available combinations of one or more items among enumerated related items.

Further, it should be appreciated that the term “comprise/include” and/or “comprising/including” means presence of corresponding features and/or components. However, it should be appreciated that the term “comprises/includes” and/or “comprising/including” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

And, the term “at least one of A or B” should be interpreted to mean “a case including only A”, “a case including only B”, and “a case in which A and B are combined”.

In the present disclosure terms represented by N-th such as first, second, or third are used for distinguishing at least one entity. For example, entities expressed as first and second may be the same as each other or different from each other.

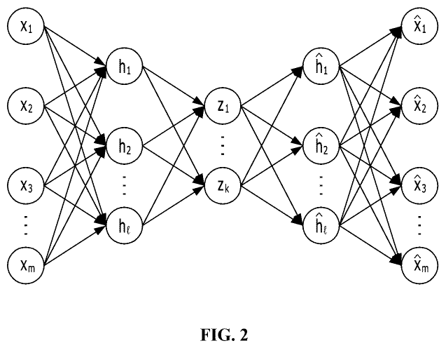

In the present disclosure, an artificial intelligence model may refer to a program or a set of functions designed as a mathematical and statistical structure to learn patterns from data and to automatically perform tasks such as prediction, classification, generation, and/or inference for a given input. The artificial intelligence model may be constructed by modeling a relationship between input and output in the form of a function. Specific examples of the artificial intelligence model will be described later with reference to FIG. 2.

In the present disclosure, a framework may refer to a set of libraries and tools for designing, building, training, evaluating, and deploying an artificial intelligence model. The framework may refer to software that enhances efficiency and reproducibility of model development. The framework may refer to a development environment for constructing an artificial intelligence model. The framework may also be used in a broad sense to refer to an execution environment and/or runtime of an artificial intelligence model. For example, the framework may be exemplified as TensorFlow, PyTorch, ONNX, TensorFlow Lite, TensorRT, JAX, and MXNet.

In the present disclosure, an intermediate representation structure may refer to a standardized representation format used at an intermediate stage for optimizing a computation graph or structure of a model for a specific execution environment or platform. The intermediate representation structure of the present disclosure may include a graph corresponding to an artificial intelligence model, modules representing layers (or operators) defined dependently on a framework, and nodes representing atomic operators as minimum units constituting the modules. The intermediate representation structure of the present disclosure may refer to an intermediate structure or a temporary structure for modification to enable execution of the artificial intelligence model in various frameworks and/or various platforms. The intermediate representation structure of the present disclosure may include a graph structure. The intermediate representation structure may be generated such that nodes independent of the framework and modules, which are sets of nodes, have a hierarchical structure or dependency relationship.

The intermediate representation structure of the present disclosure may be configured to include nodes corresponding to framework-independent atomic operators (e.g., aten operators), modules dependent on the framework, and tensors connecting nodes and/or connecting modules. A tensor is a data structure used to represent inputs, outputs, weights, intermediate calculation values, and/or quantization values of an artificial intelligence model. For example, a tensor may have an array structure in a multidimensional form. For example, a tensor may store reference information for transformation or optimization of an artificial intelligence model. For example, a tensor may be stored in an edge connecting nodes, and/or may be located in an edge connecting modules. For example, a tensor may be located in an input to a module or a node, and/or may be located in an output from a module or a node.

The intermediate representation structure of the present disclosure may include, for example, a static graph of a deep learning framework such as TensorFlow or ONNX, and/or a dynamic graph in an Eager execution mode of a deep learning framework such as PyTorch. For example, the intermediate representation structure may be generated by receiving an artificial intelligence model in the form of a static graph, by receiving an artificial intelligence model in the form of a dynamic graph, and/or by receiving an artificial intelligence model to which one or more model optimization tools have been applied.

In the present disclosure, a platform may include hardware on which an artificial intelligence model is executed and/or a compiler that connects the artificial intelligence model to the hardware. In one embodiment, the platform may include hardware. In one embodiment, the platform may include a compiler. In one embodiment, the platform may represent a combination of hardware and compiler. In one embodiment, the platform may be referred to as an execution environment, a deployment target, a system configuration, a runtime environment, and/or an inference platform in which the artificial intelligence model can be executed.

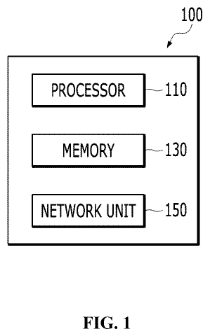

FIG. 1 is a block diagram of a computing device for modifying an operator through channel axis tracking in an artificial intelligence model according to one embodiment of the present disclosure.

A configuration of the computing device 100 illustrated in FIG. 1 is only an example illustrated through simplification. In one embodiment of the present disclosure, the computing device 100 may include other components for performing a computing configuration of the computing device 100 and only some of the disclosed components may constitute the computing device 100.

The computing device 100, according to some embodiments of the present disclosure, may be a device for transforming an artificial intelligence between a framework and an intermediate representation. The computing device 100 may include any type of server and/or any type of device. The server may include, for example, any type of computer system or computer device, such as a microprocessor, mainframe computer, digital processor, portable device, device controller, web server, application server, or database server.

In one embodiment, the computing device 100 may include a user device. For example, the computing device 100 may correspond to a user device that receives data resources generated by any server and performs additional information processing. The user device may include, but is not limited to, a personal computer, notebook, mobile terminal, smart phone, tablet PC, or other device owned by the user.

The computing device 100 may include a processor 110, a memory 130, and a network unit 150.

The processor 110 may be composed of one or more cores and may include a processor for performing operations related to data processing, such as a central processing unit (CPU), a general-purpose graphics processing unit (GPGPU), a digital signal processor (DSP), a tensor processing unit (TPU), or a neural processing unit (NPU). The processor 110 may perform data processing for transforming artificial intelligence model between framework and intermediate representation according to an embodiment of the present disclosure, by reading a computer program stored in the memory 130. In other words, a computer program stored in a computer-readable storage medium (e.g., the memory 130) may cause one or more processors (e.g., the processor 110) to perform operations for transforming artificial intelligence model between framework and intermediate representation, in accordance with an embodiment of the present disclosure. In addition, the processor 110 may implement any component for performing data processing to transform artificial intelligence model between framework and intermediate representation, according to an embodiment of the present disclosure.

According to one embodiment of the present disclosure, the processor 110 may also perform a computation for learning a neural network. For example, the processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, DSP, TPU, and NPU of the processor 110 may process learning of a network function. For example, both the CPU and the GPGPU may process the learning of the network function and data classification using the network function. Further, in one embodiment of the present disclosure, processors of the plurality of computing devices may be used together to process the learning of the network function and the data classification using the network function.

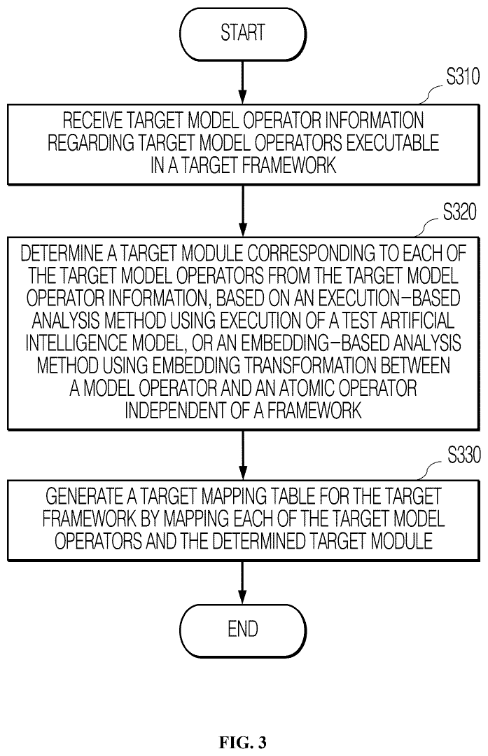

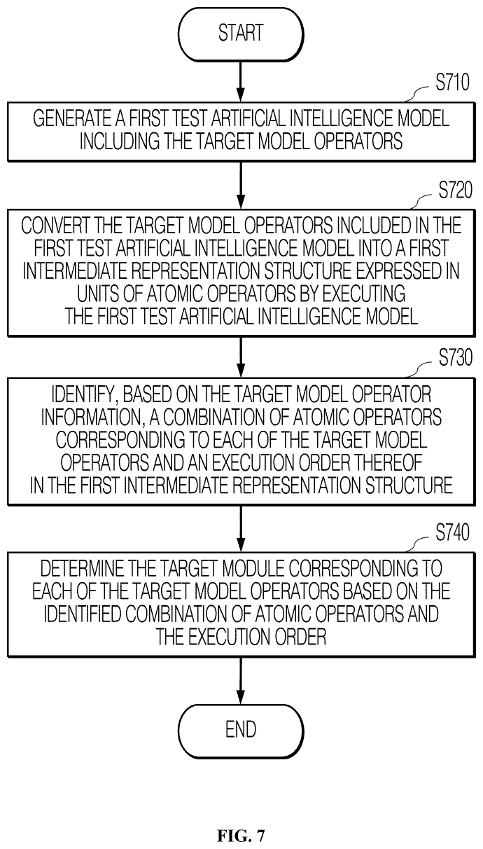

The processor 110 may generally control the overall operation of the computing device 100. For example, the processor 110 may perform the steps included in the flowchart of FIG. 3, and FIG. 7 to 9 which will be described below. By processing signals, data, or information that are input or output through the components included in the computing device 100 or by driving the application program stored in the memory 130, the processor 110 may provide or process appropriate information or functions for the user.

In one embodiment, the computing device 100 may include a system on chip (SoC). For example, the computing device 100 may include one chip on which the processor 110, the memory 130, and the network unit 150 illustrated in FIG. 1 are all mounted. In this case, the SoC may further include any modules for implementing the operation of the computing device 100, such as an I/O interface, a power management IC (PMIC), a security module, etc. Meanwhile, it will be apparent to those skilled in the art that the SoC may be referred to as a processor. Therefore, it should be interpreted that, in the embodiment, operations performed by the processor 110 in the present disclosure may be performed in the SoC.

In one embodiment of the present disclosure, the memory 130 may store any type of information generated or determined by the processor 110 and/or any type of information received by the network unit 150. In one embodiment, the memory 130 may store model operator information regarding model operators executable in each of the frameworks, version-based mapping tables of each of the frameworks in which the model operators and modules are mapped, test artificial intelligence models for each framework, etc.

In one embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The computing device 100 may operate in connection with a web storage performing a storing function of the memory 130 on the Internet. The memory 130 may include an embedded memory mounted inside the processor 110 and/or a memory mounted outside the processor 110 within the computing device 100. The above description of the memory is just an example and the memory 130 used in the present disclosure is not limited thereto. The memory 130 may be operated by the processor 110.

According to one embodiment of the present disclosure, the network unit 150 may implement any type of wired or wireless communication network capable of transmitting and receiving various types of data and signals. The technologies described in the present specification may be implemented not only through the networks mentioned above, but also through other types of networks.

FIG. 2 illustrates a network function according to one embodiment of the present disclosure.

Throughout the present disclosure, the artificial intelligence model, the artificial intelligence based model, the operation model, and the neural network, the network function, and the neural network may be used interchangeably to refer to the same concept.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In one embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to one embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in the artificial intelligence based model of the present disclosure may be learned in at least one scheme of supervised learning, unsupervised learning, semi supervised learning, or reinforcement learning, federated learning for distributed deep learning, and incremental learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data.

As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to one embodiment of the present disclosure, a computer-readable medium storing a data structure is disclosed. The above-described data structure may be stored in the memory 130 of the present disclosure, executed by the processor 110, and transmitted or received by the network unit 150.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

The artificial intelligence based model according to one embodiment of the present disclosure may include a large language model (LLM). The large language model in the present disclosure may mean an artificial intelligence based model trained by using a vast amount of learning data to perform natural language processing. The large language model may include the transformer, an encoder-series model of the transformer, and/or a decoder-series model of the transformer. The encoder-series model of the transformer may correspond to an artificial intelligence model using an encoder structure of the transformer. The decoder-series model of the transformer may correspond to an artificial intelligence model using a decoder structure of the transformer. For example, the artificial intelligence based model according to the present disclosure may include a GPT series large language model, a Bidirectional Encoder Representations from Transformers (BERT) series large language model, etc.

In one embodiment, the transformer may be constituted by an encoder that encodes input data and a decoder that decodes the encoded data. The transformer may have a structure which inputs a series of input data, and outputs a series of output data through encoding and decoding steps. In one embodiment, the series of input data may be processed into a form which is operable by the transformer. A process of processing the series of input data into the form which is operable by the transformer may include a tokenizing process and an embedding process. The tokenizing process may mean a process of dividing the series of input data into tokens of a predetermined unit. For example, the predetermined unit may include a word unit. The embedding process may mean a process of transforming at least one token tokenized from the series of input data into an embedding vector.

In one embodiment, the transformer may acquire an embedding vector to be input into the encoder by combining a token embedding vector which embeds at least one token corresponding to the series of input data, a segment embedding vector which segments a sentence including a token for each token, and a position embedding vector to which a position of the token is reflected. The encoder-series model and the decoder-series model of the transformer may also acquire the embedding vector by performing the same scheme.

In one embodiment, in order for the transformer to encode and decode a series of input data, the encoder and the decoder within the transformer may utilize an attention algorithm. The attention algorithm may mean an algorithm that calculates a similarity by applying a SoftMax function to an attention score acquired by a matrix multiplication of a given query and a key, and calculates an attention value for the query by performing a matrix multiplication of the calculated similarity and a value.

In one embodiment, a self-attention algorithm may mean an attention algorithm that uses the query, the key, and the value generated by multiplying the same embedding vector by each of a query weight, a key weight, and a value weight. A cross attention algorithm may mean an attention algorithm that uses a query generated by multiplying a first embedding vector by the query weight, and a key and a value generated by multiplying a second embedding vector by the key weight and the value weight, respectively. The query weight, the key weight, and the value weight may be trainable parameters which are updated through a training process of a large language model.

In one embodiment, the encoder of the transformer may include an embedding layer, a self-attention layer in which the self-attention algorithm is applied to the embedding vector, a normalization layer, and a feed forward neural network (FFN). Further, the encoder may have a form in which N unit structures including the self-attention layer, the normalization layer, and the feed forward neural network (FFN) are connected. The decoder of the transformer may include the embedding layer, a masked self-attention layer, the normalization layer, a cross attention layer to which the cross attention algorithm is applied, and the feed forward neural network. Further, the decoder may have a form in which N unit structures including the masked self-attention layer, the normalization layer, the cross attention layer, and the feed forward neural network are connected. The masked self-attention layer may correspond to a layer that obtains an attention value for each of the sequences sequentially including words in a plurality of words included in the series of input data.

The transformer may also include additional components such as a linear layer, a SoftMax layer, etc., in addition to the encoder and the decoder. Each of the encoder-series model of the transformer and the decoder-series model of the transformer may also include the additional components in addition to the encoder and the decoder. A method for constituting the transformer by using the attention algorithm may include a method disclosed in Vaswani et al., Attention Is All You Need, 2017 NIPS, which is incorporated herein by reference.

In one embodiment, the attention layer such as the self-attention layer, the masked self-attention layer, the cross attention layer, etc., may correspond to a multi-head attention layer including a plurality of attention layers in parallel. The multi-head attention layer matrix-concatenates attention values output from the plurality of attention layers, respectively, and matrix-multiplies the concatenated matrix by an output weight to output an output attention value. An output attention value output from the multi-head attention layer may have the same size as an attention value output from one attention layer.

In one embodiment, the transformer may be trained through a masked language model (MLM) process, a next sentence prediction (NSP) process, etc. The MLM process may mean a training process that predicts a masked word through a series of training data in which some words are masked. The NSP process may mean a training process that discriminates whether two sentences are concatenated sentences in a series of training data including any two sentences.

In one embodiment, the large language model may process various data formats including image data, audio data, video data, etc., in addition to a natural language text. In order to convert data with various data formats into a series of data that are computable, the large language model may embed the data. The large language model may process additional data expressing a relative positional relationship or phase relationship between a series of input data. Alternatively, the series of input data may be embedded by additionally reflecting vectors to the series of input data, the reflecting vectors expressing relative positional relationships or phase relationships between the input data. In one example, the relative positional relationship between a series of input data may include a word order within the natural language sentence, a relative positional relationship of respective segmented images, a temporal order of segmented audio waveforms, etc., but is not limited thereto. A process of adding information expressing a relative positional relationship or phase relationship between a series of input data may be referred to as positional encoding.

One example (Vision Transformer, ViT) of the large language model which processes image data is disclosed in Dosovitskiy, et al., An Image is Worth 16×16 Words: Transformers for Image Recognition at Scale, which is incorporated herein by reference.

The artificial intelligence model according to one embodiment of the present disclosure may include a multi-modal large language model. The multi-modal large language model may mean a large language model that may understand and process a relationship between different data formats including natural language text data, image data, audio data, video data, etc. The multi-modal language model may include a plurality of encoders which encode input data corresponding to each data format. The multi-modal language model may be trained to calculate a similarity between embedding vectors encoded from the encode, which have respective data formats through training data including data with different data formats, calculate a similarity for the same pair to be higher, and calculate a similarity for different pairs to be lower.

One example (Contrastive Language-Image Pre-training, CLIP) of the multi-modal large language model which understands and processes the relationship between the image data and the natural language text data is disclosed in Alec Radford, et al., Learning Transferable Visual Models from Natural Language Supervision, which is incorporated herein by reference.

Hereinafter, a method for transforming an artificial intelligence model between a framework and an intermediate representation, performed by a computing device 100 according to an embodiment of the present disclosure, will be described. Hereinafter, operations performed by a processor 110 of the computing device 100 will be expressed as being performed by the computing device 100.

FIG. 3 is a flowchart illustrating a method for transforming an artificial intelligence model between a framework and an intermediate representation, performed by the computing device 100 according to an embodiment of the present disclosure. The flowchart illustrated in FIG. 3 is merely an exemplary sequence, and some steps may be omitted, the order of steps may be changed, or other steps may be added within a range obvious to those skilled in the art.

In step S310, the computing device 100 according to an embodiment may receive target model operator information regarding target model operators executable in a target framework. In the present disclosure, the target framework may refer to a framework to be mapped with modules as intermediate representations of the model operators. In the present disclosure, a model operator and a layer may be used interchangeably. In the present disclosure, a module may be an intermediate representation corresponding to a model operator executable in a specific framework, and may correspond to a single model operator (or a layer). A module may be composed of a combination of one or more nodes corresponding to atomic operators. A node may correspond to an atomic operator, which is a minimum unit that is universally applicable to a plurality of frameworks (i.e., framework-independent), called when executing a model operator in an execution environment. For example, a target module, as the intermediate representation of a target model operator, may be composed of a combination of one or more nodes corresponding to atomic operators. The target module may correspond to a module dependent on the target framework.

In one embodiment, the target model operator information may include identification information, description information, input/output information, and implementation code of each of the target model operators. For example, the identification information may include an operator of each of the target model operators. The description information may be information in which a definition and a description of each of the target model operators are written in natural language text. For example, the description information may include a definition of the operator, an operation type, an operation category, an operation method, a natural language manual for the operator, etc. The input/output information may include data type (for example, tensor, scalar, float32, int32, etc.), shape, and order information of input values and output values of each of the target model operators. For example, the shape of an input value may include input parameters included in the input value and dimensional information of each of the input parameters. The shape of an output value may include output parameters included in the output value and dimensional information of each of the output parameters. The target model operator information may further include corresponding target framework information. For example, the implementation code of a model operator may correspond to programming code describing an operation of the model operator. The implementation code may further include annotations for the operator and/or code unit. In addition, the target model operator information may include a signature of the target model operator including a target model operator name and input/output information.

In one embodiment, the intermediate representation may have a hierarchical structure including nodes independent of the framework and modules dependent on the framework. One or more nodes may constitute a single module within the hierarchical structure. A single module may be a set of nodes corresponding to a single model operator. A module and a node may have a hierarchical structure of an upper layer and a lower layer. A module and a node may have a dependency relationship in which a node belongs to the module.

In step S320, the computing device 100 according to an embodiment may determine a target module corresponding to each of the target model operators from the target model operator information, based on an execution-based analysis method using execution of a test artificial intelligence model, or an embedding-based analysis method using embedding transformation between a model operator and an atomic operator independent of a framework. In the present disclosure, the execution-based analysis method may refer to a method of analyzing or determining a target module corresponding to each target model operator based on execution results or output values according to a specific input value of a test artificial intelligence model composed of at least one target model operator. In the present disclosure, the embedding-based analysis method may refer to a method of analyzing or determining a target module corresponding to each target model operator, without executing a separate test artificial intelligence model, based on semantic similarity calculated by converting each target model operator information and pre-stored candidate modules into embedding vectors. In determining the target module, the execution-based analysis method and the embedding-based analysis method may be performed alone or used complementarily.

In the present disclosure, the expression “dependent on a framework” means that it varies depending on a specific framework. Since each module in the intermediate representation structure is framework-dependent, the form of the module and information of nodes in the module may be differently configured depending on the specific framework. For example, a first intermediate representation structure may be composed of first modules suitable for a first framework in which a first test artificial intelligence model is executable. The first modules may be determined based on the first framework. Each node in the first modules may be framework-independent and may correspond to an atomic operator that cannot be further decomposed.

For example, the computing device 100 may determine atomic operators corresponding to each of the target model operators (e.g., target layers) and may generate target modules including the determined atomic operators. The target modules may be generated respectively by combining the atomic operators in accordance with the target framework. The computing device 100 may convert each of the target model operators (e.g., target layers) into a target module composed of framework-independent nodes, thereby generating a target intermediate representation structure representing a test artificial intelligence model with target modules and nodes. The target modules may correspond to target model operators (for example, target layers) dependent on the target framework.

In the present disclosure, a test artificial intelligence model may refer to a simplified artificial intelligence model used to determine a target module corresponding to each of the target model operators through the execution-based analysis method. In one embodiment, the computing device 100 may generate a test artificial intelligence model. Alternatively, the computing device 100 may receive a test artificial intelligence model. For example, the test artificial intelligence model may refer to an artificial intelligence model received and/or input from a user terminal. For example, the test artificial intelligence model may refer to a model composed of one or more target model operators or target layers executable in the target framework.

In one embodiment, the test artificial intelligence model may include all of the target model operators executable in the target framework. In another embodiment, the test artificial intelligence model may include a plurality of sub-test artificial intelligence models including a part of the target model operators executable in the target framework. In this case, all of the target model operators may be included in the plurality of sub-test artificial intelligence models. That is, the test artificial intelligence model may include multiple sub-test artificial intelligence models that can cover all of the target model operators. The test artificial intelligence model may be defined by framework. For example, the computing device 100 may generate a first test artificial intelligence model executable in a first framework to determine a target module of a first model operator corresponding to the first framework, and may generate a second test artificial intelligence model executable in a second framework to determine a target module of a second model operator corresponding to the second framework.

In one embodiment, the test artificial intelligence model may include framework information in which the test artificial intelligence model is executable. For example, the test artificial intelligence model may include identification information of the artificial intelligence model, execution file information of the artificial intelligence model, training dataset information of the artificial intelligence model, execution environment information of the artificial intelligence model, and/or framework information of the artificial intelligence model. For example, the computing device 100 may receive information identifying the test artificial intelligence model or a file of the test artificial intelligence model, and may extract training dataset information, execution environment information, and/or framework information of the artificial intelligence model using the received information or file.

In one embodiment, the test artificial intelligence model may include a plurality of target model operators (or layers). In the present disclosure, a layer may refer to a stepwise operation unit in an artificial intelligence model including one or more operators that perform computation. The computing device 100 may receive a test artificial intelligence model from an external server or a user terminal connected by wire or wirelessly, or may obtain a test artificial intelligence model developed based on connection relationships and attributes of layers set according to user input. Receiving the test artificial intelligence model may be used interchangeably with receiving user input defining a structure of the test artificial intelligence model including connection relationships and attributes of layers.

In step S330, the computing device 100 according to an embodiment may generate a target mapping table for the target framework by mapping each of the target model operators and the determined target module. In the present disclosure, the term “transform” may refer to a conversion at a model-level or framework-level, whereas the term “convert” may refer to a conversion at an operator-level or component-level. In the present disclosure, the term “transform” may be used interchangeably with the term “convert”. In the present disclosure, the target mapping table may refer to a table mapping the target model operators executed in the target framework and the target modules as intermediate representations corresponding thereto. For example, each target model operator and a target module may be mapped 1:1. The target mapping table may correspond to a mapping table dependent on the target framework. The computing device 100 may generate mapping tables corresponding to each of a plurality of frameworks, based on model operator information regarding model operators executable in each of the plurality of frameworks.

In one embodiment, the target mapping table may include version information of the framework, identification information of the target model operator, input/output information of the target model operator, identification information of one or more nodes included in the target module mapped to the target model operator, input/output information of the one or more nodes, and an execution order of each node. The identification information of the node may include an operator name of the atomic operator corresponding to the node. The input/output information of the node may include data type, shape, and order information of input values and output values of the atomic operator corresponding to the node. In the present disclosure, the execution order of the nodes may refer to a calling order of the nodes invoked by the execution environment of the artificial intelligence model.

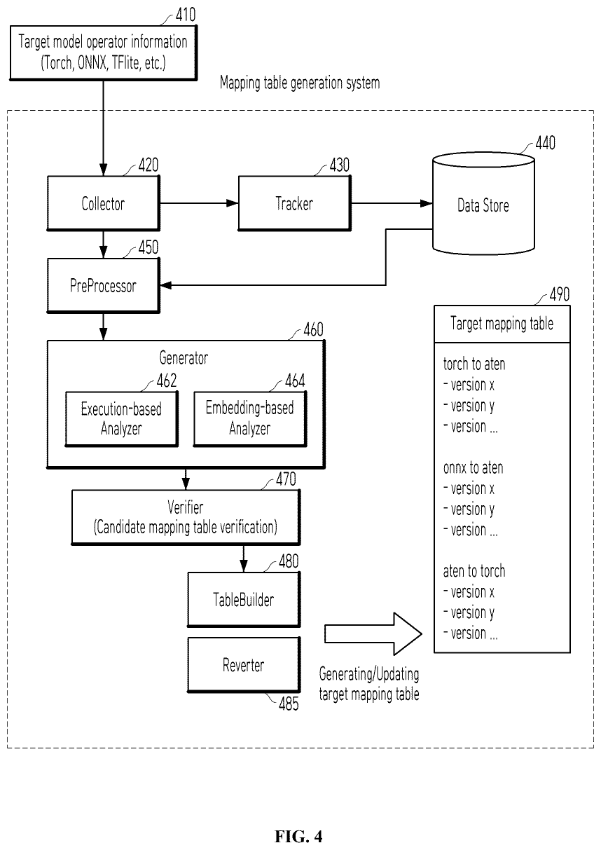

FIG. 4 is an exemplary diagram illustrating a mapping table generating system implemented by a computing device according to an embodiment of the present disclosure.

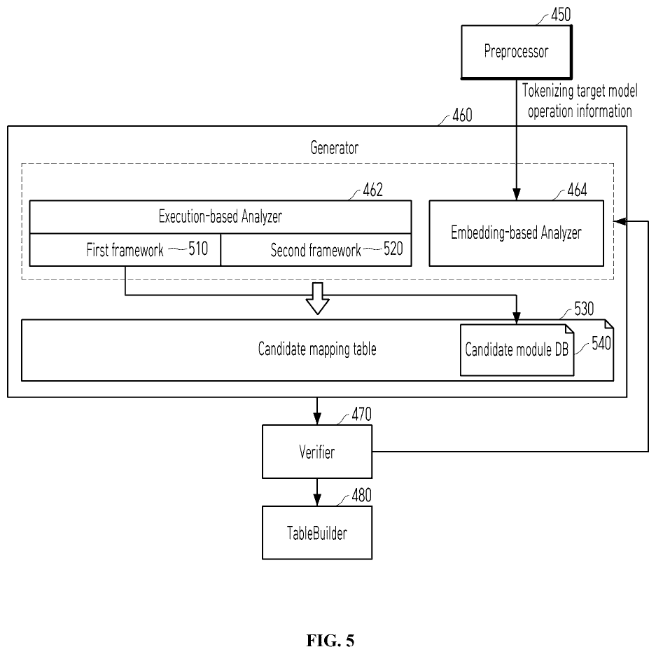

In one embodiment, the computing device 100 may implement a mapping table generating system between a framework and an intermediate representation. For example, the computing device 100 may implement a mapping table generating system according to some embodiments of the present disclosure by controlling components such as a collector 420, a tracker 430, a data store 440, a preprocessor 450, a generator 460, an execution-based analyzer 462, an embedding-based analyzer 464, a verifier 470, a table builder 480, and a reverter 485, illustrated in FIG. 4. Each component may refer to a software component performing a specific function in the computing device 100. Operations performed by each component should be understood as being performed by the computing device 100. Meanwhile, the components of the mapping table generating system illustrated in FIGS. 4 and 5 are merely exemplary, and within a scope apparent to those skilled in the art, some components may be omitted or added.

In one embodiment, the collector 420 of the computing device 100 may collect target model operator information 410. The tracker 430 of the computing device 100 may track a version of a target framework in the target model operator information 410 collected by the collector 420. In addition, the tracker 430 may track modification information updated in the version of the target framework in the target model operator information 410. For example, the tracker 430 may compare model operator information stored in the data store 440 by framework and version and may store and manage the modification information in the data store 440 in a format such as “model operator information_framework_version_{diff}”. In addition, the tracker 430 may track version-based modification information of mapping tables and may store it in a format such as “table_framework_version_{diff}”. The stored data may be used when an error occurs due to version compatibility during a process of transforming an artificial intelligence model between frameworks by the computing device 100. The collector 420 and/or the tracker 430 may store version-based target model operator information 410 in the data store 440. The data store 440 may correspond to a raw data storage space storing target model operator information 410 corresponding to raw data for generating a target mapping table 490.

In one embodiment, the preprocessor 450 may perform a function of preprocessing the target model operator information 410 into a form processable by the generator 460 in order to determine a module corresponding to a target model operator (e.g., storing, converting, etc.). For example, the preprocessor 450 may perform a function of tokenizing the target model operator information 410 and/or atomic operator information so that the generator 460 may perform the embedding-based analysis method 464. The generator 460 may perform a function of determining candidate modules corresponding to target model operators based on the target model operator information 410. For example, since there are cases where an atomic operator called is determined based on a size of input data at a time when a test artificial intelligence model is executed, the computing device 100 may identify operator information called by executing the test artificial intelligence model and tracing model operators through the execution-based analysis method. The verifier 470 may perform a verification function of determining a target module corresponding to a target model operator among candidate modules determined by the generator 460. Depending on an implementation, the verification process through the verifier 470 may be omitted.

In one embodiment, the table builder 480 may map a target model operator to a target module finally determined by the generator 460 and/or the verifier 470 and may perform a function of generating and/or updating a target mapping table 490 in a document form structured with a predetermined scheme. The target mapping table 490 may correspond to a lookup table representing a conversion relation between target model operators of a target framework and target modules (or nodes included in the target modules). The target mapping table 490 may further include arguments used for operating the target model operators in the target framework, in addition to the conversion relation between the target model operators and the target modules. The arguments may include input/output information of the target model operators. The target mapping table 490 may use the target model operators as keys and may use the corresponding target modules as values. The computing device 100 may generate mapping tables for each framework by performing the same process as the process of generating the target mapping table 490. In this case, the computing device 100 may identify a combination of nodes matching with a combination of a framework type and an operator type based on the framework-specific mapping tables.

In one embodiment, the computing device 100 may determine a target model operator corresponding to each atomic operator based on a mapping relation between each of the target model operators and the determined target module. The reverter 485 of the computing device 100 may determine a target model operator corresponding to each atomic operator based on the mapping relation between each of the target model operators and the determined target module. For example, the reverter 485 may perform a function of reverting the target mapping table 490 in which a target module is mapped to a target model operator, to map a model operator backward to an atomic operator. The reverter 485 may determine a mapping relation between atomic operators corresponding to nodes included in a target module and target model operators, based on the target modules mapped to each of the target model operators. The reverter 485 may determine target model operators corresponding to each of the atomic operators based on the mapping relation between atomic operators and target model operators. That is, the reverter 485 may generate a reverse mapping table in a format of Atomic Operator to {Framework}, based on a mapping table in a format of {Framework} to Atomic Operator.

In one embodiment, the computing device 100 may generate a target reverse mapping table by mapping each of the atomic operators and the determined target model operator. A third mapping table may refer to the target reverse mapping table. The reverter 485 of the computing device 100 may generate a target reverse mapping table by mapping each of the atomic operators and the determined target model operator. In one embodiment, the target reverse mapping table may be included in the target mapping table. The reverter 485 may add the mapping relation between atomic operators and target model operators and/or the target reverse mapping table to the target mapping table. The reverter 485 may generate and/or update the target mapping table by mapping each of the atomic operators and the determined target model operator. The table builder 480 and/or the reverter 485 may update the target mapping table 490 based on the target model operator information 410 collected periodically.

In one embodiment, in receiving the target model operator information 410, the computing device 100 may receive the target model operator information 410 by version of the target framework. In this case, the target mapping table 490 may include a version-based target mapping table for the target framework. For example, the collector 420 may collect version-based target model operator information 410 at a predetermined cycle. The computing device 100 may store version-based target model operator information 410 in the data store 440. For example, the collector 420 may collect model operator information of each framework (e.g., operator manual, operator implementation code, etc.) (e.g., by web scraping) and may store the information in the data store 440 by framework and version in a format such as “framework_{version}”. The collector 420 may store description information and implementation code included in the model operator information in the data store 440 by framework and version.

In one embodiment, the computing device 100 may generate modification information including a modification between target model operator information 410 on a first version of a target framework and target model operator information 420 on a second version of the target framework. For example, as a version of the target framework is updated, when at least some of identification information, description information, input/output information, or implementation code of each of the target model operators is modified, the computing device 100 may identify the modified model operator. For example, the tracker 430 of the computing device 100 may track modification information updated according to a version update in version-based target model operator information 410 of the target framework collected by the collector 420. The tracker 430 may separately store and/or manage the modification information in the data store 440.

In one embodiment, the computing device 100 may determine a modified module corresponding to a modified model operator, in which the target model operator information 410 has been modified, among the target model operators, from the modification information based on the execution-based analysis method or the embedding-based analysis method. For example, the generator 460 of the computing device 100 may determine a modified module corresponding to a modified model operator among the target model operators, in which the target model operator information 410 has been modified, from the modification information based on the execution-based analysis method or the embedding-based analysis method. For example, the computing device 100 may re-determine and update a module for the modified model operator among all of the target model operators executable in the target framework.

In one embodiment, the computing device 100 may generate a version-based target mapping table by mapping a modified model operator and a determined modified module. The table builder 480 of the computing device 100 may generate a version-based target mapping table by mapping a modified model operator and a determined modified module. In one embodiment, the computing device 100 may generate a target mapping table of a second version by mapping a modified model operator in which model operator information is modified and a determined modified module, as the target framework is updated from a first version to a second version. For example, when information of a specific target model operator is modified as the target framework is updated from the first version to the second version, the computing device 100 may re-map an existing module mapped to the modified model operator in the target mapping table of the first version to a re-determined modified module, thereby generating the target mapping table of the second version. In addition, the computing device 100 may generate a modification mapping table corresponding to modify information by mapping a modified model operator and a determined modified module. The computing device 100 may separately generate and store a modification mapping table including only modification information between versions of the target framework. In the present disclosure, “modification” of module and/or operator may be used interchangeably with “change” of module and/or operator.

FIG. 5 is an exemplary diagram illustrating a process of generating a mapping table according to an embodiment of the present disclosure.

In one embodiment, as described above, the preprocessor 450 may perform a function of tokenizing target model operator information 410 and/or atomic operator information so that the embedding-based analyzer 464 may perform the embedding-based analysis method. For example, the preprocessor 450 may tokenize target model operator information 410 corresponding to each of the target model operators to generate a plurality of target model operator tokens. In addition, the preprocessor 450 may perform a filtering process of deleting tokens corresponding to predefined stopwords or selecting tokens corresponding to predefined keywords for the plurality of target model operator tokens. In another example, the preprocessor 450 may generate a plurality of atomic operator tokens obtained by tokenizing information regarding the atomic operators. The preprocessor 450 may be generated by performing a filtering process of deleting tokens corresponding to the predefined stopwords or selecting tokens corresponding to the predefined keywords for the plurality of atomic operator tokens. The information regarding the atomic operators may include at least one of identification information, description information, input/output information, implementation code, or a signature of the atomic operator.

In the present disclosure, the predefined stopwords may refer to general expressions that are frequently used to describe an operation of an operator in model operator information and/or information regarding the atomic operators, but do not significantly contribute to distinguishing each operator. For example, the predefined stopwords may include general verbs (e.g., perform, return, etc.), modifiers (e.g., optionally, efficiently, etc.), and repetitive terms (e.g., this function, this operator, etc.). In the present disclosure, the predefined keywords may refer to terms that characterize and distinguish each of the model operators and/or atomic operators. For example, the predefined keywords may include operation actions (e.g., convolution, matrix multiplication, etc.), and input/output data structures (tensor, scalar, shape, etc.).

In one embodiment, the predefined stopwords and keywords may be determined based on overall occurrence frequencies of terms appearing in an operator information set including model operator information and information regarding the atomic operators, and/or occurrence frequencies of terms appearing in specific operator information. For example, the computing device 100 may define stopwords to be excluded from tokens to be subjected to embedding transformation and keywords to be included in tokens to be subjected to embedding transformation, based on a TF-IDF technique. The computing device 100 may determine terms having a TF-IDF score greater than or equal to a first predetermined score as keywords and may determine terms having a TF-IDF score less than or equal to a second predetermined score as stopwords.

In one embodiment, the generator 460 may determine candidate modules corresponding to target model operators from the target model operator information 410 based on the execution-based analysis method and/or the embedding-based analysis method. The generator 460 may generate a candidate mapping table 530 including candidate modules. In the candidate mapping table 530, one target model operator may be mapped to one or more candidate modules. The verifier 470 may obtain execution results of one target model operator and each of the one or more candidate modules by inputting test input data to one target model operator and each of the one or more candidate modules mapped to the one target model operator in the candidate mapping table 530 and executing them. For example, the verifier 470 may drive the generator 460 to obtain execution results by inputting test input data different from test input data input to each of the target model operators and the candidate modules when generating the candidate mapping table 530, and executing them. The verifier 470 may determine one target module to be mapped to one target model operator among the one or more candidate modules by comparing the execution results. Thereafter, the table builder 480 may generate a target mapping table based on a mapping relation between the determined target model operators and target modules.

In one embodiment, the execution-based analysis method may include different classification methods for a first framework 510 and a second framework 520. For example, when the target framework is the first framework 510, the target module may be determined based on a first execution-based analysis method of tracing atomic operators called during execution of the test artificial intelligence model. In another example, when the target framework is the second framework 520, the target module may be determined based on a second execution-based analysis method of comparing execution results of the test artificial intelligence model or based on the embedding-based analysis method. That is, the generator 460 may generate a candidate mapping table 530 based on the first execution-based analysis method of tracing operators called during execution of the test artificial intelligence model when the target framework is the first framework 510, and may generate a candidate mapping table 530 based on the second execution-based analysis method of comparing output values obtained by executing the test artificial intelligence model or the embedding-based analysis method when the target framework is the second framework 520.

In one embodiment, the first framework 510 may correspond to a framework supporting a function of converting model operators included in a test artificial intelligence model into an intermediate representation structure expressed in units of atomic operators. In the present disclosure, the intermediate representation structure may be used interchangeably with an intermediate representation graph. For example, the first framework 510 may correspond to a Torch framework supporting a function of generating a dynamic graph during runtime by tracing operations of model operators in an artificial intelligence model (e.g., PyTorch) and converting it into an intermediate representation structure. When the computing device 100 performs execution-based analysis for the first framework 510, the computing device 100 may determine one first module corresponding to a first model operator by dynamically tracing model operators in the test artificial intelligence model during runtime. In this case, the verification process by the verifier 470 may be omitted, and the table builder 480 may generate a target mapping table based on a mapping relation between the first model operator and the first module determined by the generator 460.

In one embodiment, the second framework 520 may correspond to a framework not supporting a function of converting model operators included in a test artificial intelligence model into an intermediate representation structure expressed in units of atomic operators. For example, the second framework 520 may correspond to a non-Torch framework, such as TensorFlow, which does not support a function of dynamically generating an operation graph by tracing operations of model operators in an artificial intelligence model other than generating a static graph, or converting it into an intermediate representation structure.

In one embodiment, when the target framework is the second framework 520, a step of determining a target module may be performed after generating a first mapping table for the first framework 510. The first mapping table may correspond to a mapping table in which each of first model operators executable in the first framework 510 is mapped to a corresponding first module. An operation of determining a second module for second model operators executable in the second framework 520 may be performed based on the first mapping table for the first framework 510. For example, the execution-based analyzer 462 of the computing device 100 may store a plurality of first modules determined to correspond to each of the first model operators of the first framework 510 in a candidate module database (DB) 540 after generating the first mapping table for the first framework 510 based on the execution-based analysis method. The candidate module DB 540 may store combinations of atomic operators included in each of the plurality of first modules and execution orders thereof. A mapping relation between the second model operators and second modules may be generated based on combinations of atomic operators and execution orders pre-stored in the candidate module DB 540. The candidate module DB 540 may store module combination templates corresponding to combination patterns of modules.

In one embodiment, when the target framework is the second framework 520, the computing device 100 may generate a candidate mapping table 530 corresponding to the target framework based on the second execution-based analysis method or the embedding-based analysis method. The computing device 100 may determine a target module corresponding to each of the target model operators by comparing execution results of each of the target model operators and execution results of each of the one or more candidate modules mapped in the candidate mapping table 530. That is, when the target framework is the second framework 520, the target module may be determined based on: generating a candidate mapping table 530 corresponding to the target framework using the second execution-based analysis method or the embedding-based analysis method, and determining a target module corresponding to each of the target model operators by comparing execution results of each of the target model operators and execution results of each of the one or more candidate modules mapped in the candidate mapping table 530. The candidate mapping table 530 may correspond to a table in which one or more candidate modules are mapped to one target model operator. The generating the candidate mapping table 530 may be characterized by being performed using a plurality of first modules predetermined for the first framework.

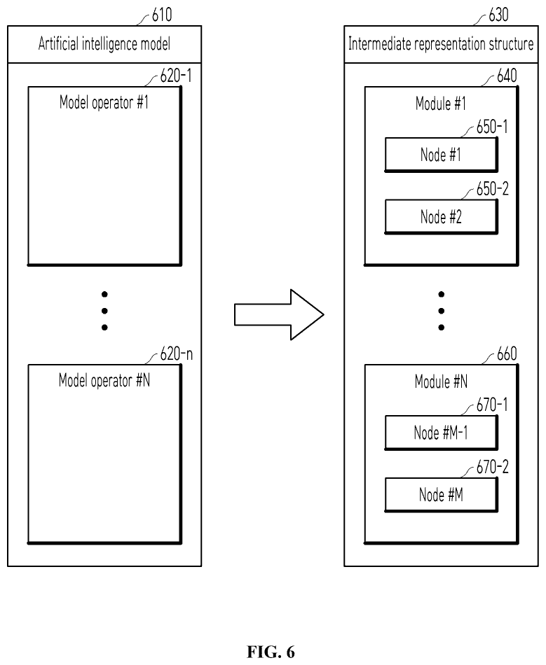

FIG. 6 is an exemplary diagram illustrating a process of converting a model operator into a module of an intermediate representation structure according to an embodiment of the present disclosure.

In one embodiment, an artificial intelligence model (e.g., a test artificial intelligence model) 610 may be composed of one or more model operators 620-1, 620-n. In the present disclosure, the model operator may be used as a concept encompassing a layer that performs a single operation. The computing device 100 may convert the artificial intelligence model 610 into an intermediate representation structure 630 including framework-independent nodes and framework-dependent modules. For example, when frameworks of artificial intelligence models performing the same operation are different, different modules may be included in the intermediate representation structure 630, and when frameworks of artificial intelligence models performing the same operation are different, the same node may still be included in the intermediate representation structure 630. For example, in the intermediate representation structure 630, one module may include one or more nodes. At this time, a node may correspond to an atomic operator which is a minimum unit operator independent of the framework.

For example, the generator 460 of the computing device 100 may obtain a first test artificial intelligence model executable in a first framework 510. The generator 460 may dynamically convert the first test artificial intelligence model into a first intermediate representation structure by executing the first test artificial intelligence model. In this case, the model operators included in the first test artificial intelligence model may be converted into modules as intermediate representations in the first intermediate representation structure.

As illustrated in FIG. 6, a first model operator 620-1 included in the artificial intelligence model 610 may be converted into a first module 640 in the intermediate representation structure 630. The first module 640 may include a first node 650-1 and a second node 650-2. For example, when the first model operator 620-1 corresponds to a convolution operation, the first node 650-1 may correspond to a matrix multiplication operation and the second node 650-2 may correspond to an addition operation. Likewise, an Nth model operator 620-n may be converted into an Nth module 660 in the intermediate representation structure 630. The Nth module 660 may include an (M-1)th node 670-1 and an Mth node 670-2.

Hereinafter, detailed descriptions of the execution-based analysis method and the embedding-based analysis method are disclosed. The flowcharts illustrated in FIGS. 7 to 9 are merely exemplary sequences, and some steps may be omitted, the order may be changed, or other steps may be added within a scope apparent to those skilled in the art.

FIG. 7 is a flowchart illustrating a method for converting a model operator of a first framework into an intermediate representation using an execution-based analysis method, performed by a computing device according to an embodiment of the present disclosure. The computing device 100 according to one embodiment may determine a target module by performing the steps of FIG. 7 when the target framework is the first framework 510.

In step S710, when the target framework is the first framework 510, the computing device 100 according to one embodiment may generate a first test artificial intelligence model including target model operators in determining the target module. At this time, the first test artificial intelligence model may correspond to a model executable in the first framework 510. The first test artificial intelligence model may include one or more model operators and/or layers executable in the first framework 510.

In step S720, the computing device 100 according to one embodiment may convert target model operators included in the first test artificial intelligence model into a first intermediate representation structure expressed in units of atomic operators by executing the first test artificial intelligence model. That is, the computing device 100 may dynamically generate the first intermediate representation structure by tracing target model operators called during execution of the first test artificial intelligence model. The target model operators included in the first test artificial intelligence model may correspond to first model operators executable in the first framework. The first intermediate representation structure may be expressed in units of modules that are sets of atomic operators.

In step S730, the computing device 100 according to one embodiment may identify, based on the target model operator information, a combination of atomic operators corresponding to each of the target model operators and an execution order thereof in the first intermediate representation structure. The first intermediate representation structure may include combinations of atomic operators having a predetermined execution order corresponding to each of the first model operators corresponding to the first framework.

In step S740, the computing device 100 according to one embodiment may determine a target module corresponding to each of the target model operators based on the identified combination of atomic operators and the execution order. For example, the computing device 100 may determine a target module corresponding to each of the target model operators based on identification information (e.g., operator names) of the target model operators and identification information of the atomic operators. The computing device 100 may determine first modules corresponding to the first framework based on atomic operators having a predetermined execution order included in the first intermediate representation structure. A target module corresponding to a first model operator executable in the first framework 510 may be referred to as a first module. In one embodiment, the computing device 100 may store a plurality of first modules including combinations of atomic operators and execution orders in a candidate module DB. The computing device 100 may subsequently utilize the plurality of first modules stored in the candidate module DB in a second execution-based analysis method and/or an embedding-based analysis method for a second framework. For example, the computing device 100 may perform a target module determination operation in the second execution-based analysis method and/or the embedding-based analysis method for the second framework by using a combination of atomic operators and an execution order corresponding to each of the plurality of first modules pre-stored as one candidate module.

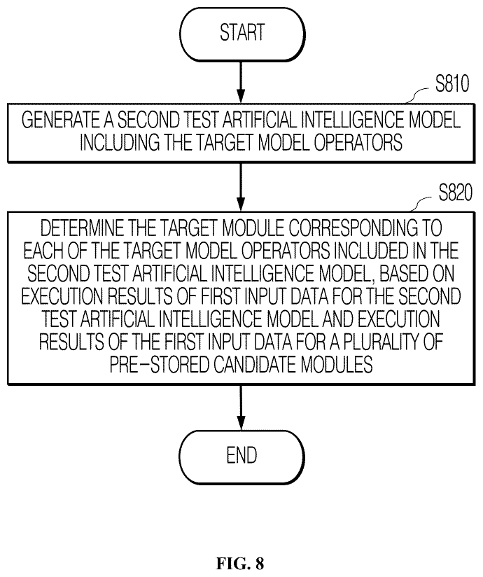

FIG. 8 is a flowchart illustrating a method for converting a model operator of a second framework into an intermediate representation using an execution-based analysis method, performed by a computing device according to an embodiment of the present disclosure. The computing device 100 according to one embodiment may determine a target module by performing the steps of FIG. 8 when the target framework is the second framework 520.

In step S810, when the target framework is the second framework 520, the computing device 100 according to one embodiment may generate a second test artificial intelligence model including target model operators in determining the target module. The second test artificial intelligence model may correspond to a model executable in the second framework 520. The second test artificial intelligence model may include one or more model operators and/or layers executable in the second framework 520.

In step S820, the computing device 100 according to one embodiment may determine a target module corresponding to each of the target model operators included in the second test artificial intelligence model, based on execution results of first input data for the second test artificial intelligence model and execution results of the first input data for a plurality of pre-stored candidate modules. For example, input data may correspond to an input tensor input to a model operator and a candidate module. The computing device 100 may generate input data with combinations of various input forms and arguments (args, kwargs, etc.). A target module corresponding to a second model operator executable in the second framework may be referred to as a second module. The plurality of pre-stored candidate modules may correspond to the plurality of first modules predetermined for the first framework 510. When the second test artificial intelligence model is executed, based on a runtime dispatch method, a kernel corresponding to a data type (e.g., float32, int8, etc.) of the input data among a plurality of kernels capable of performing the same operation may be selected and the model operator may be executed.

In one embodiment, a second test artificial intelligence model may consist of a single first target model operator. In this case, in determining a target module based on execution results of first input data for the second test artificial intelligence model and execution results of the first input data for a plurality of pre-stored candidate modules, the computing device 100 may generate an error between execution results of the first input data for the first target model operator and execution results of the first input data for the plurality of pre-stored candidate modules. In the present disclosure, the term “generating” an error may be used interchangeably with “calculating” or “determining” an error. The execution result for the first input data may correspond to a first output value output by inputting the first input data into the target model operator or the candidate module. For example, the error may be generated based on an absolute error, a relative error obtained by dividing the absolute error by the execution result value of the first target model operator or the candidate module, an L2Norm, MSE (Mean Squared Error), and/or a cosine similarity.

In one embodiment, the computing device 100 may identify one or more candidate modules among the plurality of pre-stored candidate modules in which the error between execution results of the first input data for the first target model operator and execution results of the first input data for each of the candidate modules is less than or equal to a threshold error. The computing device 100 may determine the target module corresponding to the first target model operator among the identified one or more candidate modules, by comparing execution results of second input data for the first target model operator and execution results of the second input data for the identified one or more candidate modules. For example, the verifier 470 may determine the target module corresponding to the first target model operator among the identified one or more candidate modules by using second input data, different from the first input data, as test input data.

In one embodiment, the computing device 100 may determine one or more candidate modules in which the error between execution results of the first input data for the first target model operator and execution results of the first input data for the plurality of pre-stored candidate modules is less than a first threshold error. In another example, the computing device 100 may identify one or more temporary candidate modules in which the error between execution results of the first input data for the first target model operator and execution results of the first input data for the plurality of pre-stored candidate modules is greater than or equal to the first threshold error and/or less than a second threshold error. The computing device 100 may determine one or more candidate modules based on a user input selecting some of the temporary candidate modules. The one or more candidate modules may correspond to candidate modules selected from among the temporary candidate modules based on the user input.

In one embodiment, in determining a target module based on execution results of first input data for the second test artificial intelligence model and execution results of the first input data for a plurality of pre-stored candidate modules, the computing device 100 may generate an error between execution results of the first input data for the second test artificial intelligence model and execution results of the first input data for candidate module combinations composed of the plurality of pre-stored candidate modules. One candidate module combination may include at least one pre-stored candidate module. The computing device 100 may identify one or more candidate module combinations in which the error is less than or equal to a threshold error among the candidate module combinations. The computing device 100 may determine a target module corresponding to each of the target model operators included in the second test artificial intelligence model within the identified one or more candidate module combinations, by comparing execution results of third input data for each of the target model operators and execution results of the third input data for each of the candidate modules included in the identified one or more candidate module combinations. That is, the computing device 100 may identify a combination of candidate modules and an execution order thereof corresponding to a combination of target model operators and an execution order thereof of the second test artificial intelligence model, and may determine a candidate module corresponding to each target model operator.

In one embodiment, the second test artificial intelligence model may include a second target model operator and a third target model operator. The third target model operator may receive an output value of the second target model operator as input. In determining a target module based on execution results of first input data for the second test artificial intelligence model and execution results of the first input data for a plurality of pre-stored candidate modules, the computing device 100 may generate a first error between a first intermediate execution result of the second target model operator for the first input data and execution results of the first input data for the plurality of pre-stored candidate modules. The first intermediate execution result for the first input data of the second target model operator may correspond to an output value of the second target model operator output by inputting the first input data into the second target model operator. The computing device 100 may identify one or more first candidate modules among the plurality of pre-stored candidate modules in which the first error is less than or equal to a threshold error.

In one embodiment, the computing device 100 may generate a second error between a second intermediate execution result output by the third target model operator using the first intermediate execution result as input and execution results output by the plurality of pre-stored candidate modules using the first intermediate execution result as input. The second intermediate execution result for the first intermediate execution result of the third target model operator may correspond to an output value of the third target model operator output by inputting the first intermediate execution result, which is the output value of the second target model operator, into the third target model operator. The computing device 100 may identify one or more second candidate modules among the plurality of pre-stored candidate modules in which the second error is less than or equal to the threshold error.

In one embodiment, the computing device 100 may determine a target module corresponding to each of the second target model operator and the third target model operator, based on the identified one or more first candidate modules and the identified one or more second candidate modules. For example, the computing device 100 may generate an error between execution results of the second target model operator for fifth input data and execution results of one or more first candidate modules, and may determine a target module corresponding to the second target model operator among the one or more first candidate modules. Similarly, the computing device (100) may generate an error between execution results of the third target model operator for the fifth input data and execution results of one or more second candidate modules, and may determine a target module corresponding to the third target model operator among the one or more second candidate modules.

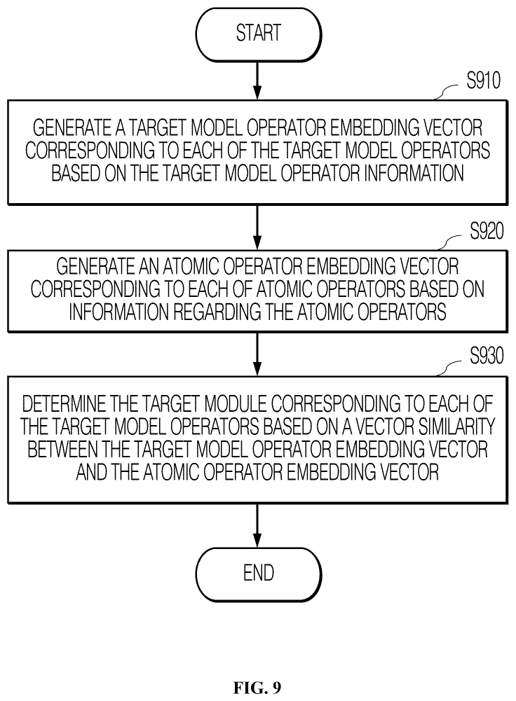

FIG. 9 is a flowchart illustrating a method for converting a model operator into an intermediate representation using an embedding-based analysis method, performed by a computing device according to an embodiment of the present disclosure.

In step S910, the computing device 100 according to one embodiment may generate a target model operator embedding vector corresponding to each of the target model operators based on target model operator information. For example, the computing device 100 may generate a target model operator embedding vector by inputting text corresponding to the target model operator information into a pre-trained embedding model. For example, the embedding model may correspond to a sentence embedding model for converting text in sentence units into embedding vectors, such as a large language model, Sentence-BERT (SBERT), Universal Sentence Encoder (USE), etc. The computing device 100 may convert each of a plurality of target model operator tokens tokenized from the target model operator information into a target model operator token embedding vector using the embedding model, and may generate an integrated target model operator embedding vector based on the plurality of target model operator token embedding vectors.

In step S920, the computing device 100 according to one embodiment may generate an atomic operator embedding vector corresponding to each of the atomic operators based on information regarding the atomic operators. For example, the computing device 100 may generate an atomic operator embedding vector by inputting text corresponding to information regarding each of the atomic operators into the embedding model. The computing device 100 may convert each of a plurality of atomic operator tokens tokenized from the atomic operator information into an atomic operator token embedding vector using the embedding model, and may generate an integrated atomic operator embedding vector based on the plurality of atomic operator token embedding vectors.

In one embodiment, the computing device 100 may obtain target model operator information in a text format processable by the embedding model from the target model operator information using a pre-trained large language model. For example, the large language model may output target model operator information in a sentence-level text format by receiving target model operator information including identification information, description information, implementation code, etc. as input. The computing device 100 may obtain atomic operator information in a text format processable by the embedding model from the atomic operator information using the large language model. For example, the large language model may output atomic operator information in a sentence-level text format by receiving atomic operator information including identification information, description information, implementation code, etc. as input.

In one embodiment, the target model operator embedding vector may be generated by performing a filtering process of deleting tokens corresponding to predefined stopwords or selecting tokens corresponding to predefined keywords for the plurality of target model operator tokens obtained by tokenizing the target model operator information corresponding to each of the target model operators. Similarly, the atomic operator embedding vector may be generated by performing a filtering process of deleting tokens corresponding to predefined stopwords or selecting tokens corresponding to predefined keywords for the plurality of atomic operator tokens obtained by tokenizing the information regarding the atomic operators.

In step S930, the computing device 100 according to one embodiment may determine a target module corresponding to each of the target model operators based on a vector similarity between the target model operator embedding vector and the atomic operator embedding vector. That is, the computing device 100 may determine the target module based on a semantic similarity between a target model operator and an atomic operator. In one embodiment, in determining the target module based on the vector similarity, the computing device 100 may determine one or more candidate atomic operators corresponding to one or more atomic operator embedding vectors in which a vector similarity with a target model operator embedding vector corresponding to a fourth target model operator is greater than or equal to a threshold vector similarity. The computing device 100 may identify one or more candidate modules including one or more candidate atomic operators among a plurality of pre-stored candidate modules. For example, the computing device 100 may determine a first candidate atomic operator corresponding to a first atomic operator embedding vector having a vector similarity with the target model operator embedding vector corresponding to the fourth target model operator greater than or equal to the threshold vector similarity. The computing device 100 may identify one or more candidate modules including the first candidate atomic operator among the plurality of pre-stored candidate modules.

In one embodiment, the computing device 100 may determine one or more candidate atomic operators corresponding to one or more atomic operator embedding vectors having a vector similarity with the target model operator embedding vector corresponding to the fourth target model operator greater than or equal to a first threshold vector similarity. In another example, the computing device 100 may identify one or more temporary candidate atomic operators corresponding to one or more atomic operator embedding vectors having a vector similarity with the target model operator embedding vector corresponding to the fourth target model operator less than the first threshold vector similarity and/or greater than or equal to a second threshold vector similarity. The computing device 100 may determine one or more candidate atomic operators based on a user input selecting some of the temporary candidate atomic operators. The one or more candidate atomic operators may correspond to candidate atomic operators selected from among the temporary candidate atomic operators based on the user input.

In one embodiment, the computing device 100 may determine a target module corresponding to the fourth target model operator among the identified one or more candidate modules by comparing execution results of fourth input data for the fourth target model operator and execution results of the fourth input data for the identified one or more candidate modules. In this case, the plurality of pre-stored candidate modules may correspond to a plurality of first modules predetermined for the first framework.

Through the present disclosure, it is possible to achieve a technical effect that more accurate mapping can be performed based on semantic similarity (embedding-based analysis method) and based on execution results (execution-based analysis method), compared to conventional mapping methods between model operators and atomic operators performed manually or only in a one-to-one manner. In addition, it is possible to achieve a technical effect that dynamic verification based on execution result comparison through various inputs can be performed, compared to conventional operator verification methods performed by static rule verification or manual work. In addition, it is possible to achieve a technical effect that, whereas in the past mapping between operators was manually updated as framework versions were updated, version-based mapping can be automatically performed by automatically tracking document/code modification history through the tracker. In addition, it is possible to achieve a technical effect that bidirectional mapping is possible through reverse mapping that traces model operators of a framework backward from atomic operators.

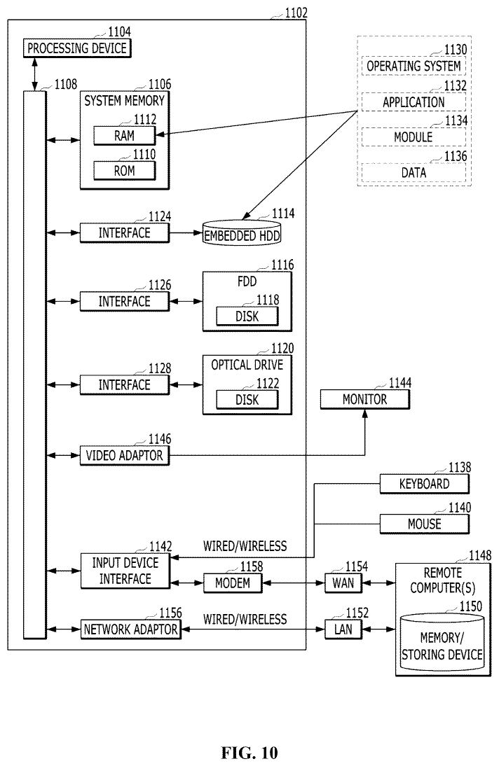

FIG. 10 is a simplified and general schematic diagram of an exemplary computing environment in which embodiments of the present disclosure may be implemented.

It is described above that the present disclosure may be generally implemented by the computing device 100, but those skilled in the art will know well that the present disclosure may be implemented in association with a computer executable instruction which may be executed on one or more computers and/or in combination with other program modules and/or a combination of hardware and software.

Generally, program modules include routines, programs, components, data structures, and the like that perform particular tasks or implement particular abstract data types. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

FIG. 10 illustrates an exemplary environment that implements various aspects of the present disclosure including a computer 1102 and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114(e.g., EIDE, SATA)—which may alternatively be configured for external use within a suitable chassis (not shown)—a magnetic floppy disk drive (FDD) 1116(e.g., for reading from or writing to a mobile diskette 1118), and an optical disk drive 1120(e.g., for reading from or writing to a CD-ROM disk 1122 or other high-capacity optical media such as a DVD). The computer 1102 may also include an external hard disk drive (HDD) 1114 connected via ports such as USB, Thunderbolt, or eSATA. The hard disk drive 1114, magnetic disk drive 1116, and optical disk drive 1120 can each be connected to the system bus 1108 via a hard disk drive interface 1124, a magnetic disk drive interface 1126, and an optical drive interface 1128, respectively. The interface 1124 for external drive implementations includes at least one of, or both, USB (Universal Serial Bus) and IEEE 1394 interface technologies.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a microprocessor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication computing device on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information. It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

What is claimed is:

1. A method for transforming an artificial model between a framework and an intermediate representation, performed by a computing device, comprising:
receiving target model operator information regarding target model operators executable in a target framework;
determining a target module corresponding to each of the target model operators from the target model operator information, based on an execution-based analysis method using execution of a test artificial intelligence model, or an embedding-based analysis method using embedding transformation between a model operator and an atomic operator independent of a framework; and
generating a target mapping table for the target framework by mapping each of the target model operators and the determined target module, and
wherein the target module, as the intermediate representation of the target model operator, is composed of a combination of one or more nodes corresponding to the atomic operator.

2. The method of claim 1, wherein
when the target framework is a first framework, the target module is determined based on a first execution-based analysis method of tracing atomic operators called during execution of the test artificial intelligence model, and
when the target framework is a second framework, the target module is determined based on a second execution-based analysis method of comparing execution results of the test artificial intelligence model or based on the embedding-based analysis method.

3. The method of claim 2, wherein
the first framework corresponds to a framework supporting a function of converting model operators included in the test artificial intelligence model into an intermediate representation structure expressed in units of atomic operators, and
the second framework corresponds to a framework not supporting a function of converting model operators included in the test artificial intelligence model into an intermediate representation structure expressed in units of atomic operators.

4. The method of claim 2, wherein
when the target framework is the second framework, the determining the target module is performed after generating a first mapping table for the first framework.

5. The method of claim 2, wherein when the target framework is the second framework, the target module is determined based on:
generating a candidate mapping table corresponding to the target framework based on the second execution-based analysis method or the embedding-based analysis method, the candidate mapping table corresponding to a table in which one or more candidate modules are mapped to one target model operator; and
determining the target module corresponding to each of the target model operators by comparing execution results of each of the target model operators and execution results of each of the one or more candidate modules mapped in the candidate mapping table, and
wherein the generating the candidate mapping table is performed using a plurality of first modules predetermined for the first framework.

6. The method of claim 2, wherein when the target framework is the first framework, the determining the target module comprises:
generating a first test artificial intelligence model including the target model operators;
converting the target model operators included in the first test artificial intelligence model into a first intermediate representation structure expressed in units of atomic operators by executing the first test artificial intelligence model;
identifying, based on the target model operator information, a combination of atomic operators corresponding to each of the target model operators and an execution order thereof in the first intermediate representation structure; and
determining the target module corresponding to each of the target model operators based on the identified combination of atomic operators and the execution order.

7. The method of claim 2, wherein when the target framework is the second framework, the determining the target module comprises:
generating a second test artificial intelligence model including the target model operators; and
determining the target module corresponding to each of the target model operators included in the second test artificial intelligence model, based on execution results of first input data for the second test artificial intelligence model and execution results of the first input data for a plurality of pre-stored candidate modules, and
wherein the plurality of pre-stored candidate modules correspond to a plurality of first modules predetermined for the first framework.

8. The method of claim 7, wherein
the second test artificial intelligence model consists of a single first target model operator, and
the determining the target module based on execution results of the first input data for the second test artificial intelligence model and execution results of the first input data for the plurality of pre-stored candidate modules comprises:
generating an error between execution results of the first input data for the first target model operator and execution results of the first input data for the plurality of pre-stored candidate modules;
identifying one or more candidate modules among the plurality of pre-stored candidate modules in which the error is less than or equal to a threshold error; and
determining the target module corresponding to the first target model operator among the identified one or more candidate modules, by comparing execution results of second input data for the first target model operator and execution results of the second input data for the identified one or more candidate modules.

9. The method of claim 7, wherein the determining the target module based on execution results of the first input data for the second test artificial intelligence model and execution results of the first input data for the plurality of pre-stored candidate modules comprises:
generating an error between execution results of the first input data for the second test artificial intelligence model and execution results of the first input data for candidate module combinations composed of the plurality of pre-stored candidate modules;
identifying one or more candidate module combinations in which the error is less than or equal to a threshold error among the candidate module combinations; and
determining the target module corresponding to each of the target model operators included in the second test artificial intelligence model within the identified one or more candidate module combinations, by comparing execution results of third input data for each of the target model operators and execution results of the third input data for each of the candidate modules included in the identified one or more candidate module combinations.

10. The method of claim 7, wherein
the second test artificial intelligence model includes a second target model operator and a third target model operator, the third target model operator receiving an output value of the second target model operator, and
the determining the target module based on execution results of the first input data for the second test artificial intelligence model and execution results of the first input data for the plurality of pre-stored candidate modules comprises:
generating a first error between a first intermediate execution result of the second target model operator for the first input data and execution results of the first input data for the plurality of pre-stored candidate modules;
identifying one or more first candidate modules among the plurality of pre-stored candidate modules in which the first error is less than or equal to a threshold error;
generating a second error between a second intermediate execution result output by the third target model operator using the first intermediate execution result as input and execution results output by the plurality of pre-stored candidate modules using the first intermediate execution result as input;
identifying one or more second candidate modules among the plurality of pre-stored candidate modules in which the second error is less than or equal to the threshold error; and
determining the target module corresponding to each of the second target model operator and the third target model operator, based on the identified one or more first candidate modules and the identified one or more second candidate modules.

11. The method of claim 1, wherein the determining the target module comprises:
generating a target model operator embedding vector corresponding to each of the target model operators based on the target model operator information;
generating an atomic operator embedding vector corresponding to each of atomic operators based on information regarding the atomic operators; and
determining the target module corresponding to each of the target model operators based on a vector similarity between the target model operator embedding vector and the atomic operator embedding vector.

12. The method of claim 11, wherein
the target model operator embedding vector is generated by performing a filtering process of deleting tokens corresponding to predefined stopwords or selecting tokens corresponding to predefined keywords for a plurality of target model operator tokens obtained by tokenizing the target model operator information corresponding to each of the target model operators, and
the atomic operator embedding vector is generated by performing a filtering process of deleting tokens corresponding to the predefined stopwords or selecting tokens corresponding to the predefined keywords for a plurality of atomic operator tokens obtained by tokenizing the information regarding the atomic operators.

13. The method of claim 11, wherein the determining the target module based on the vector similarity comprises:
determining one or more candidate atomic operators corresponding to one or more atomic operator embedding vectors in which the vector similarity with the target model operator embedding vector corresponding to a fourth target model operator is greater than or equal to a threshold vector similarity;
identifying one or more candidate modules including the one or more candidate atomic operators among a plurality of pre-stored candidate modules; and
determining the target module corresponding to the fourth target model operator among the identified one or more candidate modules by comparing execution results of fourth input data for the fourth target model operator and execution results of the fourth input data for the identified one or more candidate modules, and
wherein the plurality of pre-stored candidate modules correspond to a plurality of first modules predetermined for the first framework.

14. The method of claim 1, wherein
the target model operator information includes identification information, description information, input/output information, and implementation code of each of the target model operators,
the description information is information in which a description of each of the target model operators is written in natural language text, and
the input/output information includes data type, shape, and order information of input values and output values of each of the target model operators.

15. The method of claim 1, wherein
the receiving the target model operator information comprises receiving the target model operator information by version of the target framework,
the target mapping table includes the version-based target mapping table for the target framework, and
the method further comprises:
generating modification information including a modification between the target model operator information on a first version of the target framework and the target model operator information on a second version of the target framework;
determining a modified module corresponding to a modified model operator, in which the target model operator information has been modified, among the target model operators, from the modification information based on the execution-based analysis method or the embedding-based analysis method; and
generating the target mapping table of the second version by mapping the modified model operator and the determined modified module.

16. The method of claim 1, wherein
the target mapping table includes version information of the framework, identification information of the target model operator, input/output information of the target model operator, identification information of one or more nodes included in the target module mapped to the target model operator, input/output information of the one or more nodes, and an execution order of each node.

17. The method of claim 1, wherein
the intermediate representation has a hierarchical structure including nodes independent of the framework and modules dependent on the framework, and
one or more nodes constitute a single module within the hierarchical structure.

18. The method of claim 1, further comprising:
determining a target model operator corresponding to each of atomic operators based on a mapping relation between each of the target model operators and the determined target module; and
generating a target reverse mapping table by mapping each of the atomic operators and the determined target model operator.

19. A non-transitory computer-readable medium storing a computer program that, when executed by a computing device, allows the computing device to perform operations for transforming an artificial model between a framework and an intermediate representation, the operations comprising:
receiving target model operator information regarding target model operators executable in a target framework;
determining a target module corresponding to each of the target model operators from the target model operator information, based on an execution-based analysis method using execution of a test artificial intelligence model, or an embedding-based analysis method using embedding transformation between a model operator and an atomic operator independent of a framework; and
generating a target mapping table for the target framework by mapping each of the target model operators and the determined target module, and
wherein the target module, as the intermediate representation of the target model operator, is composed of a combination of one or more nodes corresponding to the atomic operator.

20. A computing device for transforming an artificial model between a framework and an intermediate representation, comprising a processor including at least one core,
wherein the processor is configured to:
receive target model operator information regarding target model operators executable in a target framework;
determine a target module corresponding to each of the target model operators from the target model operator information, based on an execution-based analysis method using execution of a test artificial intelligence model, or an embedding-based analysis method using embedding transformation between a model operator and an atomic operator independent of a framework; and
generate a target mapping table for the target framework by mapping each of the target model operators and the determined target module, and
wherein the target module, as the intermediate representation of the target model operator, is composed of a combination of one or more nodes corresponding to the atomic operator.
